(19) United States
(12) Patent Application Publication
(10) Pub. No.: US 2001/0029754 A1
(43) Pub. Date: Oct. 18, 2001

(54) Press mold

(75) Inventors: Masashi Fukuyama, Inuyama-City (JP); Kazutoshi Tohyama, Nakastugawa-City (JP)

Correspondence Address: BURR & BROWN, PO BOX 7068, SYRACUSE, NY, 13261-7068, US

(73) Assignee: NGK Insulators, Ltd. and NGK Optoceramics Co., Ltd.

(21) Appl. No.: 09/778,396

(22) Filed: Feb. 7, 2001

(30) Foreign Application Priority Data
Mar. 26, 1999 (JP) 11-084961

(51) Int. Cl. C03B 11/06

(52) U.S. Cl. 65/159; 65/171; 65/357; 65/374.12; 65/374.13

(57) ABSTRACT

To provide a press mold for molding glass that is relatively less expansible than a mold material. The mold is configured so that the content volume of the mold is approximately equal to the volume of molded glass at the time of press molding, and a side face member of the mold is divided into a plurality of pieces so as to be capable of moving toward an outside but incapable of moving toward an inside. Thereby, over-tightening of mold side face can be prevented effectively, and a satisfactory molding operation can be performed by transmitting a molding pressure uniformly to a molded member without opening any mold side face.

### BACKGROUND OF THE INVENTION AND RELATED ART STATEMENT

The present invention relates to a press mold usable suitably for press molding of glass such as less expansible glass or the like.

As optical fiber arrangement parts, an optical fiber array for connecting an optical fiber to other optical parts and an MT connector for connecting the optical fibers to each other are well known. These optical parts for connection are manufactured by using a glass substrate having a fiber fixing groove. A product of such a glass substrate having a groove in the surface thereof is generally manufactured by grinding or using a press mold consisting of an upper mold and a lower mold.

Specifically, the glass substrate is manufactured by pouring a melted glass material into a mold and by press molding. In press molding a plate-shaped glass substrate, the glass substrate is usually manufactured by two-step molding operation consisting of a first molding step in which molten glass is molded into a glass substrate and a second molding step in which the glass substrate obtained in the first molding step is reheated and molded more precisely.

In the case where the glass substrate having a groove in the surface thereof as described above is molded, in the second molding step, that is, in what we call a reheat press step, molding is accomplished by using a press mold consisting of an upper mold and a lower mold, either of which has a groove-shaped molding face. In the case where the glass material being press molded expands less than the mold material such as the uppermold and the lowermold, for example, in the case of a material subjected to little dimensional change by heat, such as less expansible glass, for a fitting type (bowl type) having a construction in which a press pressure is transmitted uniformly to the material, after the press molding operation is finished, the mold material shrinks during cooling, so that an over-tightening state takes place on the mold side face. For this reason, in the case of less expansible material, press molding must be accomplished with the mold side face being open. As a result, there arises a problem in which a molding pressure is not transmitted uniformly to the molded member, so that the property of transferring mold shape is decreased.

Thereupon, the present invention has been achieved to solve the problems with the related art, and accordingly an object thereof is to provide a press mold capable of performing a satisfactory molding operation by transmitting a molding pressure uniformly to a molded member without opening the mold side face.

### SUMMARY OF THE INVENTION

According to the present invention, there is provided a press mold for molding glass that is relatively less expansible than a mold material, characterized in that the mold is configured so that the content volume of the mold is approximately equal to the volume of molded glass at the time of press molding, and a side face member of the mold is divided into a plurality of pieces so as to be capable of moving toward the outside but incapable of moving toward the inside.

In the press mold in accordance with the present invention, each of the side face members is preferably formed into a tapered shape expanding from the inside toward the outside in plan view. Also, an easily releasable member is preferably disposed on the side of molding surface of the side face member to improve the mold release properties of a molded product.

Also, preferably, a highly expansible material constituting a mold side face portion is formed of stainless steel, and the easily releasable member is formed of tungsten carbide (WC).

Further, preferably, the coefficient of thermal expansion of the less expansible glass used in the present invention is 50×10⁻⁷/K and lower.

### BRIEF DESCRIPTION OF THE DRAWINGS

FIG. 1 is a schematic sectional view showing one embodiment of a press mold in accordance with the present invention, FIG. 1(a) showing an upper mold, and FIG. 1(b) showing a lower mold.

FIG. 2 is a plan view of the lower mold taken in the direction of the arrows along a line A-A′ of FIG. 1(b).

### DETAILED DESCRIPTION OF PREFERRED EMBODIMENT

A press mold in accordance with the present invention is used to mold glass that expands less than a mold material. The mold is configured so that the content volume of the mold is approximately equal to the volume of molded glass at the time of press molding (at the time of highest temperature in press molding). Moreover, a side member of mold is divided into a plurality of pieces, and is configured so that each of the divided side members can be moved toward the outside but cannot be moved toward the inside.

By configuring the press mold as described above, the side reference of mold is not moved toward the inside and is moved only toward the outside, so that over-tightening of mold side face can be prevented effectively. Therefore, even when molded glass such as less expansible glass is pressed, a mold member does not shrink toward the inside when the mold member shrinks at the time of cooling after press molding, so that over-tightening of mold side face does not occur.

An embodiment of the present invention will now be described in detail with reference to the accompanying drawings.

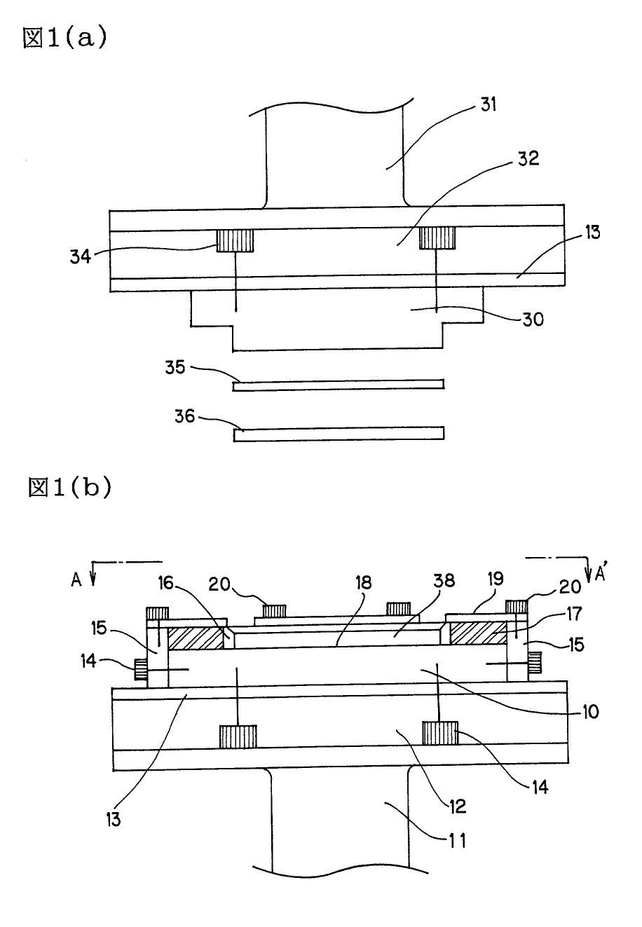

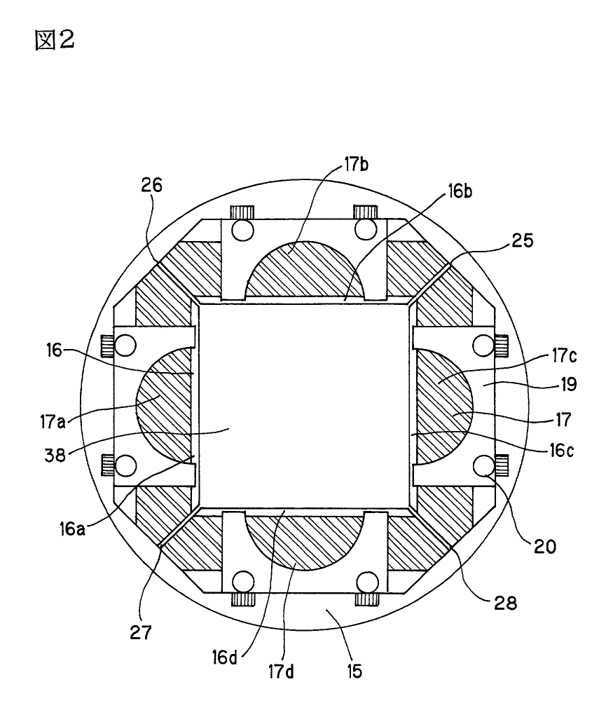

FIG. 1 is a schematic sectional view showing one embodiment of a press mold in accordance with the present invention, FIG. 1(a) showing an upper mold, and FIG. 1(b) showing a lower mold, and FIG. 2 is a plan view of the lower mold taken in the direction of the arrows along a line A-A′ of FIG. 1(b).

In FIGS. 1 and 2, reference numeral 10 denotes a lower mold, which is fixed onto a spacer 13 via a die plate 12 with screws 14 at the upper part of a joint 11. The lower mold 10 is made up of a side face mold 15, an inside face mold 16 forming a molding side face, and a block 17 that is arranged between the side face mold 15 and the inside face mold 16 and is made of a material expanded more by heat than the molded glass. Reference numeral 19 denotes a holding plate for holding the block 17 from the upside. The holding plate 19 is fixed to the side face mold 15 with screws 20. On the upper surface of the lower mold 10, a predetermined V-shaped convex portion 18 is formed.

As shown in the plan view of FIG. 2, the block 17 is divided radially into four pieces by division lines 25, 26, 27 and 28. Each of blocks 17a, 17b, 17c and 17d is formed into a tapered shape expanding from the inside toward the outside in plan view, and is arranged so as to be separated from each other with a small gap therebetween. The blocks 17a, 17b, 17c and 17d are not fixed, so that each of the blocks 17a, 17b, 17c and 17d can be moved by thermal expansion or thermal shrinkage. However, since the block 17 is divided radially into four pieces, and each of the divided blocks is formed into a tapered shape as described above, each of these blocks cannot be moved toward the inside, and can be moved only toward the outside.

In the embodiment shown in FIG. 2, the inside face mold 16 is also divided radially into four pieces so as to be formed of a plurality of members 16a, 16b, 16c and 16d. Each of the members 16a, 16b, 16c and 16d is arranged so as to be separated from each other with a small gap therebetween. Also, each of the members 16a, 16b, 16c and 16d is not fixed, so that it can be moved by thermal expansion or thermal shrinkage. However, since the inside face mold 16 is divided radially into four pieces, and each of the divided members are formed into a tapered shape, each of these members cannot be moved toward the inside, and can be moved only toward the outside.

On the other hand, an upper mold 30 is fixed to a lower part of a spacer 33 via a die plate 32 with screws 34 at the lower part of a joint 31. On the tip end surface (that is, the lower end surface) of the upper mold 30, an easily releasable carbon sheet 35 is disposed to improve the mold release properties of molded product, by which molded glass 36 is molded.

Also, for members constituting the press mold, the block 17 was formed of stainless steel (SUS304), which is a highly expansible material, considering the difference in thermal expansion between the block and the molded glass, the mold release properties, or the like. On the other hand, other members, that is, the upper mold 30, lower mold 10, side face mold 15, and inside face mold 16 were formed of tungsten carbide (WC). In particular, the inside face mold 16 is preferably formed of WC from the viewpoint of the mold release properties of molded product. Also, the upper mold may be formed of WC, but the carbon sheet 35 was disposed on the tip end surface of the upper mold 30 to improve the mold release properties. The carbon sheet 35 is preferable because it has a coefficient of thermal expansion as low as that of the molded glass.

The materials of other members, that is, the joints 11 and 31, die plates 12 and 32, and spacers 13 and 33 are not subject to any special restriction. However, considering the high strength, heat resistance, coefficient of thermal expansion, or the like, for example, the die plates 12 and 32 and the spacers 13 and 33 were formed of WC, and the joints 11 and 31 were formed of silicon nitride.

Incidentally, the coefficient of thermal expansion of WC is about 50×10⁻⁷/K, that of SUS304 is about 150×10⁻⁷/K, and that of a glass material, for example, Pyrex (made of Corning Inc.) is about 30×10⁻⁷/K.

The following is a description of the operation of the press mold in accordance with the present invention, which is configured as described above.

The press mold in accordance with the present invention is used for reheat press molding of, for example, a glass substrate. A glass substrate material obtained from molten glass, a molded material 36 shown in FIG. 1(a), is put into an interior 38 of mold, and is press molded from the upside and downside by using the upper mold 30 and the lower mold 10 while being reheated from the outside of mold.

The press mold in accordance with the present invention forms the side face mold is which is the side member, the inside face mold 16, and the block 17 so that the content volume of the mold is approximately equal to the volume of molded glass 36 at the time of press molding, that is, at the time of highest temperature in press molding. Also, the inside face mold 16 and the block 17 are configured so as to be incapable of moving toward the inside and capable of moving only toward the outside.

Accordingly, at the time when the molded glass 36 is press molded, the side reference of mold is not moved toward the inside and is moved only toward the outside, so that over-tightening of mold side face can be prevented effectively.

As described above, according to the press mold in accordance with the present invention, the side reference of mold is not moved toward the inside and is moved only toward the outside, so that over-tightening of mold side face can be prevented effectively. Therefore, even in the case where less expansible glass is press molded, a satisfactory molding operation can be performed by transmitting a molding pressure uniformly to a molded member without opening any mold side face.

What is claimed is:

1. A press mold for molding glass that is relatively less expansible than a mold material,
characterized in that said mold is configured so that the content volume of the mold is approximately equal to the volume of molded glass at the time of press molding, and a side face member of said mold is divided into a plurality of pieces so as to be capable of moving toward the outside but incapable of moving toward the inside.

2. The press mold according to claim 1, characterized in that each of said side face members is formed into a tapered shape expanding from the inside toward the outside in plan view.

3. The press mold according to claim 1, characterized in that an easily releasable member is disposed on the side of molding surface of said side face member.

4. The press mold according to claim 2, characterized in that an easily releasable member is disposed on the side of molding surface of said side face member.

5. The press mold according to claim 3, characterized in that a highly expansible material constituting a mold side face portion is formed of stainless steel, and said easily releasable member is formed of tungsten carbide (WC).

6. The press mold according to claim 4, characterized in that a highly expansible material constituting a mold side face portion is formed of stainless steel, and said easily releasable member is formed of tungsten carbide (WC).

7. The press mold according to claim 1, characterized in that the coefficient of thermal expansion of the less expansible glass is 50×10⁷/K and lower.
